(19) United States
(12) Patent Application Publication
(10) Pub. No.: US 2016/0232375 A1
(43) Pub. Date: Aug. 11, 2016

(54) METHODS AND SYSTEMS FOR PROVIDING ONLINE DIGITAL IMAGE RIGHTS MANAGEMENT AND IDENTITY PROTECTION IN A DIGITAL ENVIRONMENT

(71) Applicants: Michael R. Loeb, New York, NY (US); Edward J. McCabe, New York, NY (US)

(72) Inventors: Michael R. Loeb, New York, NY (US); Edward J. McCabe, New York, NY (US)

(21) Appl. No.: 14/962,535

(22) Filed: Dec. 8, 2015

Related U.S. Application Data
(63) Continuation of application No. 11/725,323, filed on Mar. 19, 2007, now abandoned.

(51) Int. Cl. G06F 21/62; H04L 12/58; G06F 17/30; H04L 29/08; G06K 9/62

(52) U.S. Cl. CPC G06F 21/6245; H04L 67/02; G06K 9/6215; G06F 21/6209; G06F 17/30265; G06F 17/30259; H04L 67/06; H04L 51/32

(57) ABSTRACT

Methods and systems for providing photographic rights management and identity protection. The invention is premised on the assumption that the individual that first registers an uploaded image is the rightful owner for the purposes of the uploading host website. Once rightful ownership is established in an uploaded digital image instance, the rightful owner may select the degree of protection they desire to assign over their uploaded image and are given authority over their image.

### FIELD OF THE INVENTION

The present invention relates generally to methods and systems directed to digital rights management, and more specifically, to a system and method for providing image rights management and identity protection on public networking sites.

### BACKGROUND OF THE INVENTION

A number of popular online social networking sites have emerged with the expansion of the Internet, and World Wide Web. Representative networking sites include Friendster.com (Friendster, Inc.), TheFacebook (www.thefacebook.com), and Myspace (www.myspace.com) and dating sites such as Match.com and eHarmony.com. Typically, a user wishing to participate in one of these social networking sites begins by creating a personal profile, which can be personalized to express an individual's interests and tastes, values and ruminations. In certain applications, rich media such as audio and video can also be integrated into a user's personal profile to make it more personal and appealing. The user typically links their profile to other users to generate a list (i.e., on-line social network) of “friends,” through which they can navigate to view profiles of friends of friends, and so on. Alternately, they might choose to search through a user directory to find users that meet certain criteria. In many cases, users can view all information provided by other users including their photos and profiles, see how the user is connected to other users and send messages. Sites with such functionality can be used for all types of on-line social networking, including, for example, making friends, meeting other couples, or people with kids, etc.

The dynamics of identity formation and presentation play out visibly on social networking sites. Users can express themselves through text, images and media, making connections with individuals throughout the country and world that would be impossible to make in real life. Because the virtual, on-line world requires people to “write themselves into being,”—with little ability on the part of the network to validate user-provided information—users command heretofore unheard of abilities to craft their identity according to their own desires. As peer-validation is as large a driving force in online socialization as in-person socialization, and users are afforded the ability to craft their identities per their own wishes, the temptation and ability exists for users to present themselves in a manner that will result in the most attention (generally in the form of “friend requests” and page-views); this results in a large number of profiles that are inaccurate and others that are totally fabricated.

The problem of this misrepresentation is never more fundamental and problematic than on web-based social networking sites, where relationships must be based on a fundamental trust, as there is no guarantee that another user has provided their actual photographs or information. This allows for social deception, where users can easily steal images from other users in order to present themselves as perhaps more attractive or interesting, in order to receive more attention. In most cases, the intent of positioning another user's photos as one's own is not to assume their true identify or make false purchases—as with traditional identity theft—but instead present a different user's likeness as their own. Although such identity theft is not as pernicious or harmful as theft of a credit card or social security number, it nevertheless comprises an enormous breach of mutual trust within the online social community.

Presently, sites such as MySpace.com have employees that review thousands of images uploaded each day to screen for inappropriate depictions, including pornography. This activity is performed as a response to advertiser concerns over the pairing of their brand images with inappropriate content. This diligence, however useful, unfortunately, does not extend to ensuring that end users are protected against image cloning and identity theft. At best, certain sites post rules stating that no user is allowed to post a picture of someone else on the Internet without written permission, and that if a user is under 18, they need a guardian's permission to post their picture. Given the extent of the problem, it is apparent that these rules and regulations go largely unheeded.

The present inventors have recognized a need for a system and method that reduces personal identity theft by protecting the photographs of registered users from being taken and positioned as one's own by anonymous identity thieves.

### SUMMARY OF THE INVENTION

The invention provides new and improved methods and systems for providing photographic rights management and identity protection. The invention anticipates the continued growth of public data sharing in venues such as the World Wide Web, and the continued movement toward the protection of privacy rights by anticipating a need to protect the primacy rights of member's photographs uploaded to a photo-hosting web site. In this regard, the inventors claim a process, system and associated method that protect digital images made public on internet-based social networking and other sites. The invention is premised on the assumption that the individual that first registers an uploaded image is the rightful owner. Once rightful ownership is established for an uploaded digital image, the rightful owner may select the degree of protection they desire to assign over their uploaded image and are given authority over that image.

According to one aspect of the invention, the owner of an original personal digital image instance uploads his personal digital image instance to a local photo-sharing host web site. At the local photo-sharing host web site, the image owner may view and maintain control over his uploaded personal digital image instance, as is well known. Presently, an image owner may only limit the viewers that can view the image owner's uploaded digital images or restrict the ability to save pictures from the website to the viewer's hard drive. These restrictions can be circumvented by savvy users that could use the “print screen” option to take a snap shot of their screen, and use a photo editor to save a version of the image.

These and other limitations are overcome by the invention by providing the rightful owner of a digital image with an assurance that no other subsequent individual may use a similar image to the original digital image, without permission or knowledge of the rightful owner.

According to a further aspect of the invention, means are provided for an image uploader to appeal a usage decision in the case where it is believed that a mistake has occurred in assigning user rights based on order of upload.

In some embodiments, the invention may be applied retroactively to a database of images, in the case where the host site host cannot utilize the upload order of the images as a means of assigning ownership rights.

According to yet another aspect of the present invention, there is provided an ability to utilize known pattern-matching and image recognition technology to assign primary control over an uploaded image to the first user that registers the image, and then screen, not by file name, but by the fundamental qualities of the photograph, to ensure that the person that first uploaded the image maintains their desired degree of control over the image.

### DESCRIPTION OF THE DRAWING FIGURES

These and other objects, features and advantages of the invention will be apparent from a consideration of the following Detailed Description Of The Invention considered in conjunction with the drawing Figures, in which:

FIG. 1 illustrates a multiple server system, comprised of various computers or devices running clients, which are coupled to local servers which are in turn coupled to a central server, according to one embodiment;

FIGS. 2, 2a, 2b and 2c together comprise a process for providing photographic rights management and identity protection on public networking sites, according to one embodiment;

FIG. 3 illustrates a data entry screen (GUI) for entering preference data about uploaded images, according to one embodiment; and

FIG. 4 illustrates an exemplary rights profile which is created at the data entry screen of FIG. 3, according to one embodiment.

### DETAILED DESCRIPTION OF THE INVENTION

In accordance with the present invention, there are provided herein methods and systems for providing photographic rights management and identity protection that address the need to protect images (e.g., photographs) on public networking sites. Embodiments of the invention are disclosed hereinafter for methods and systems that provide controls for deterring individuals from taking others images and positioning them as their own.

While particular reference may be made to “images” in the described embodiments, it is understood that the invention contemplates the term “image” to more broadly encompass, for example, picture files including photographs and other images, video files, audio files and the like. It should also be understood that the term “similar,” as used herein in the context of attempting to match images means that image relational software compares two images in order to establish with a large degree of certainty that two images are indeed derived from the same photograph, with allowances for editing, such as cropping, rotation inversion, color edits and differences that might arise from digital scanning of the same physical image.

### System Overview

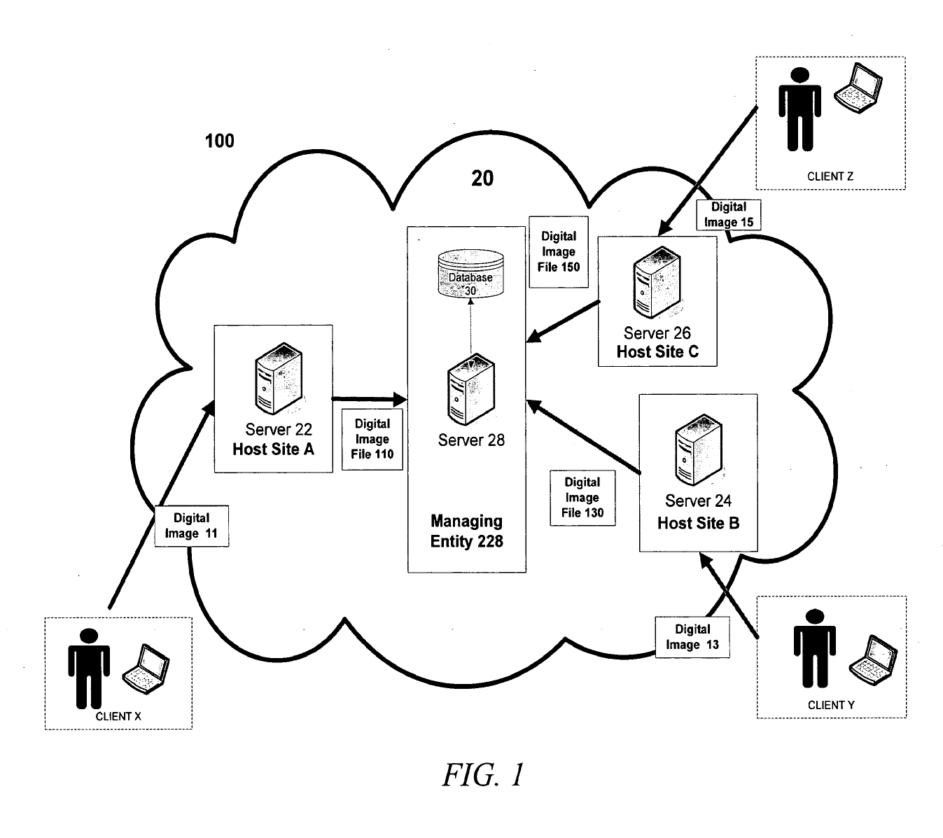

Referring now to FIG. 1, one embodiment of a photographic rights management and identity protection system 100 for protecting photographs on public networking sites, will now be described.

FIG. 1 illustrates a multiple server system 100, comprised of various computers or devices running clients X, Y and Z, which are coupled to local servers 22, 24, and 26, which are in turn coupled to a central server 28 operated by a managing entity 228. Each of the respective local servers are associated with a photo-sharing host site A, B and C, configured to allow clients X, Y and Z to upload and maintain their digital image files. For example, client X uploads digital image file 11 to server 22 of photo-sharing host site A via the wide area network 20. The wide area network 20 could be the Internet or an intranet or any other such wide area network or even a local area network. In like manner, client Y uploads digital image file 13 to server 24 of photo-sharing host site B via the wide area network 20. Similarly, client Z uploads digital image file 15 to server 26 of photo-sharing host site C via the wide area network 20.

Local photo-sharing host sites A, B and C are pre-designated to cooperate with the central server 28 for the purpose of performing the supervisory and management functions associated with the invention. Data repository 30 is shown coupled to server 28, which may be remote or co-located with server 28. Server 28 may access local servers 22, 24 and 26 and associated local photo-sharing host sites A, B and C over the wide area network 20. Although multiple servers 22, 24, 26 are shown coupled to a central server 28 in the illustrative embodiment, it should be understood that some embodiments may use only a single server to perform all of the supervisory and management functions including uploading all image files.

### Operation

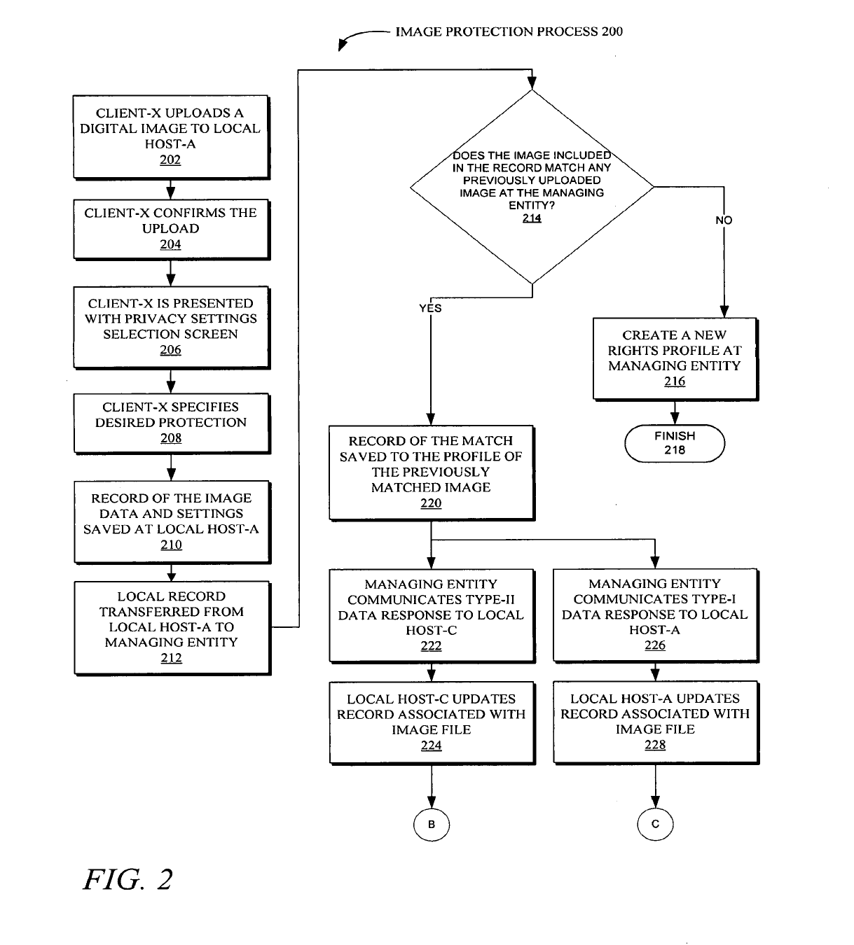

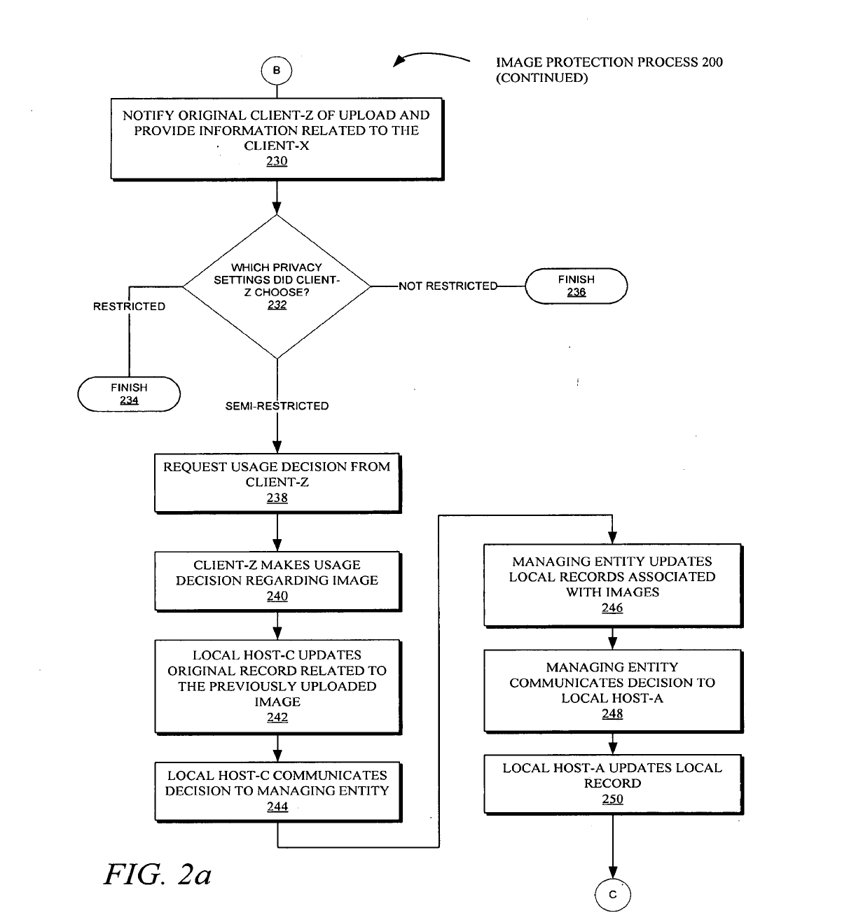

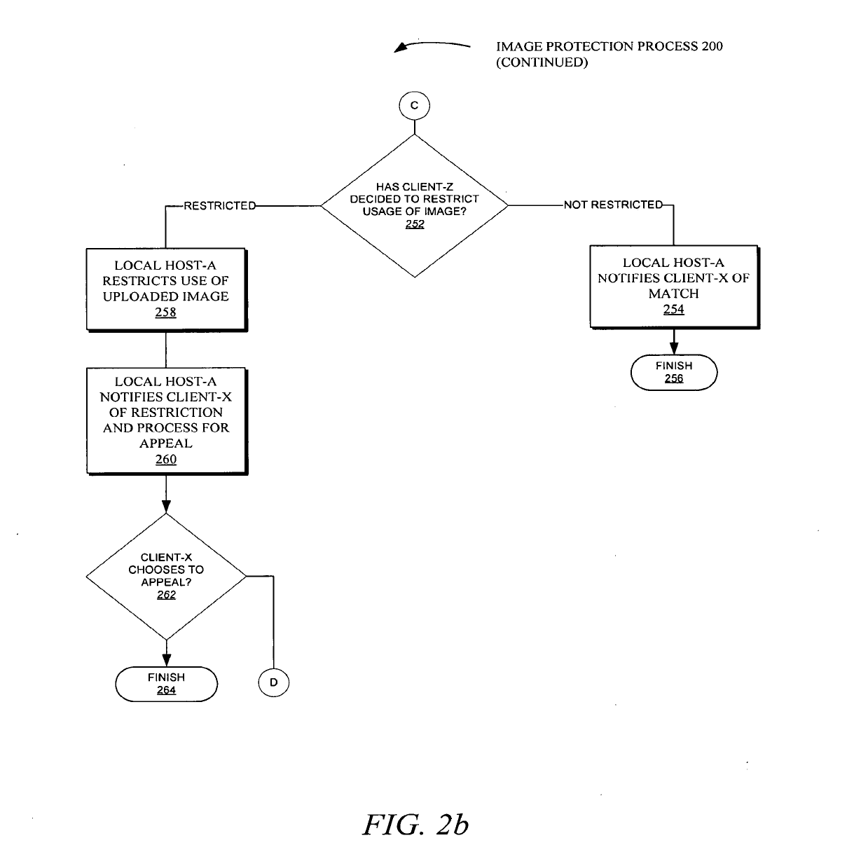

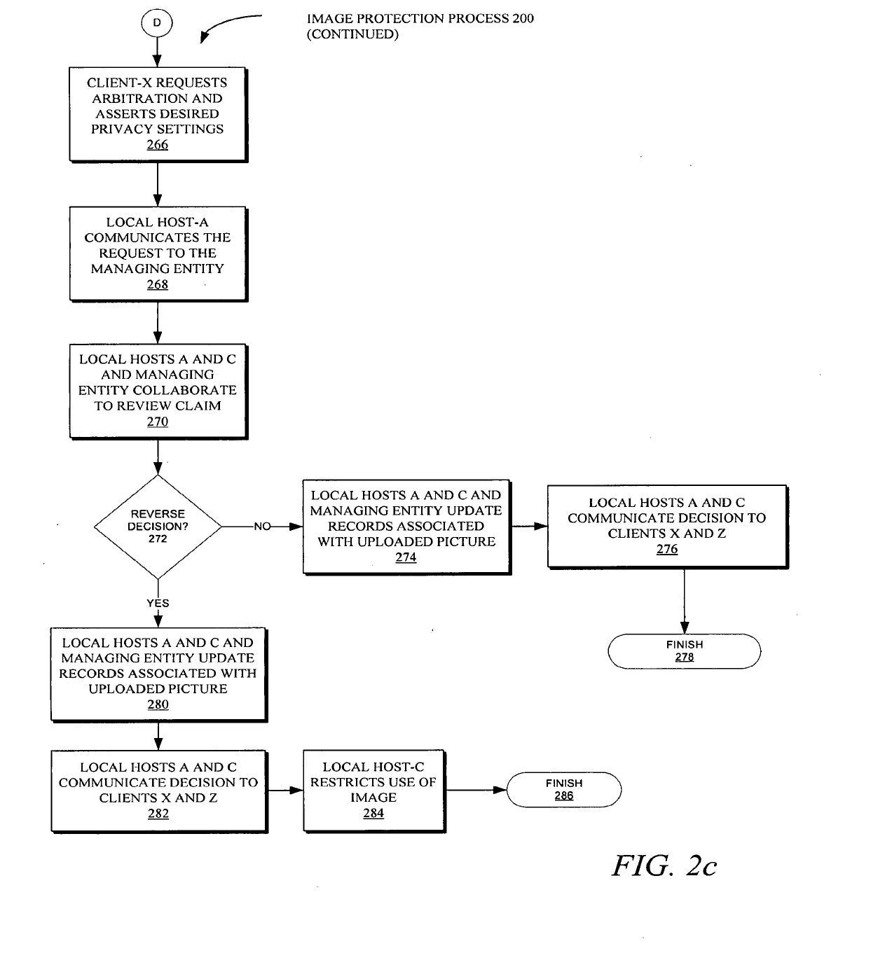

With reference now to FIG. 2, there is shown a process 200 for providing photographic rights management and identity protection on public networking sites, according to one embodiment. The process 200 is preferably executed by a multiple server system, including a plurality of local servers in data communication with a central server, such as the system illustrated in FIG. 1.

In the following description, it is assumed that in the illustrative example, a client Z uploads a digital image, such as image 15 to local host site C at an earlier point in time. At a later point in time, another client X uploads a digital image 11 to local host site A. Each of the local host sites A and C upload their respective images 11, 15, contained within an associated rights profile 110 and 150, to the central server 28. It is further assumed in the illustrative example that as a result of comparing images uploaded from the respective local host sites A, B and C, a determination is made by the managing entity 228 that the images 11 and 15 match. That is, they are determined to be similar, as defined herein.

At step 202, an uploading client, such as, for example, client X, uploads his digital image 11 to a local server 22 which is part of a local photo-sharing host site A, configured to enable clients, such as client X, to upload and maintain their digital image files (see FIG. 1).

At step 204, the uploading client X confirms the upload of his digital image 11 at the local photo-sharing host site A.

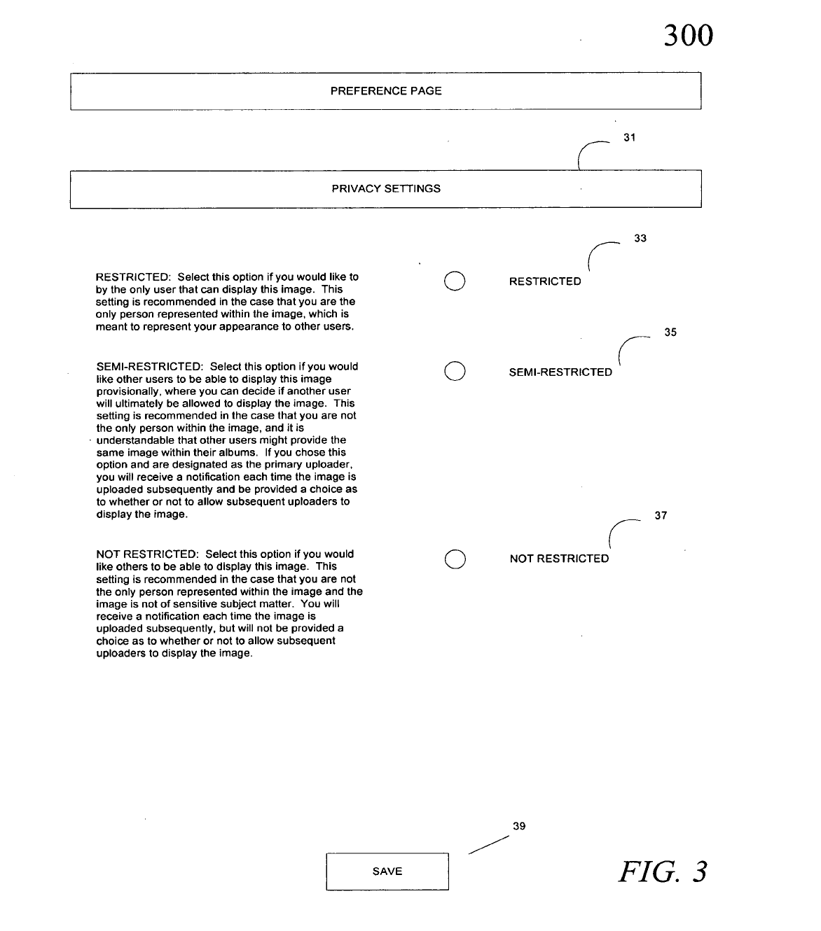

At step 206, the uploading client X is presented with a data entry screen, referred to herein as a preference page 300, described in greater detail below with reference to FIG. 3.

At step 208, the uploading client X specifies his desired privacy settings for the presently uploaded digital image 11.

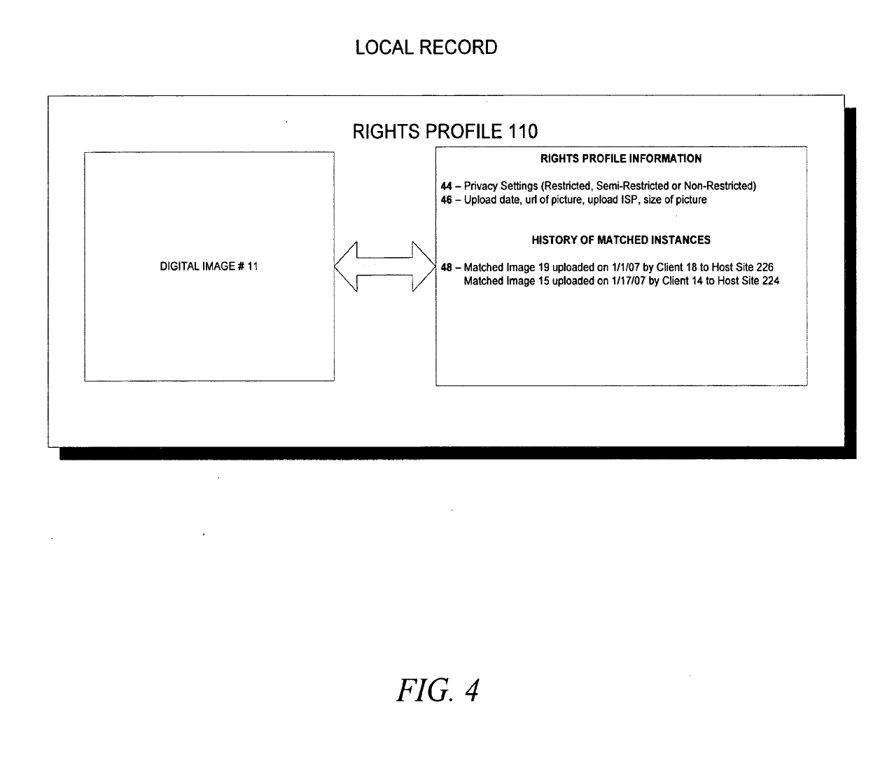

At step 210, upon depressing the “save” button 39 at preference page 300 (see FIG. 3), a local record 110 (i.e., referred to herein as a “rights profile,” as shown in FIG. 4) is created and stored locally at server 22 at local photo-sharing host site A.

At step 212, a copy of the newly created rights profile 110 is transmitted from the local photo-sharing host site A to the managing entity 228 via network 20.

At step 214, a determination is made at the managing entity 228, regarding whether digital image 11 included as an element of the presently uploaded rights profile 110 matches at least one other pre-existing digital image stored in database 30. In other words, at this step, the presently uploaded digital image 11 is compared with all of the pre-existing digital images stored in database 30 to determine whether there exists within that database any similar image(s). It is understood that the pre-existing digital images are those images which are elements of rights profiles, uploaded to the management entity 228 by various clients X, Y, Z at earlier points in time relative to digital image 11.

At step 216, in the case where it is determined at step 214 that the presently uploaded digital image 11 does not match any of the pre-existing digital images in database 30, a permanent copy of the rights profile 110, which had been uploaded at step 212, is saved in database 30 at the managing entity 228. In general, whenever it is determined that there is no match between a currently uploaded image and an existing image in database 30, a new rights profile is created, comprised of the uploaded image and other elements as described above and illustrated in FIG. 4. The new rights profile 110 is preferably stored in database 30 at the managing entity 228 in a record format.

At step 218, the process terminates.

At step 220, in the case where it is determined at step 214 that the presently uploaded digital image 11 matches previously uploaded digital image 15, uploaded from client Z, the managing entity 228 records the match between the respective images for inclusion in the rights profile 110 associated with uploaded digital image 11. An illustration of this recordation is depicted in FIG. 4 in section 48. From this step the process branches to perform steps 222 and 226, substantially simultaneously.

At step 222, the managing entity 228 communicates a “Type-II” data message to local host site C, from which the previously uploaded digital image 15 was received. The “Type-II” data message indicates that a presently uploaded image 11, identified by managing entity 228, was determined to match a previously uploaded image 15, stored within database 30 (see determination step 214).

At step 224, the local photo-sharing host site C receives the “Type-II” data message issued from the managing entity 228 and responds by updating the local record associated with the previously uploaded digital image 15 from client Z to indicate that another client X has attempted to use a presently uploaded digital image 11, which has been determined to be similar to previously uploaded digital image 15 owned by client Z. This process, involving the original photo-sharing host site C, utilized by client Z, continues at step 230.

At step 226, which substantially parallels step 222 above, the managing entity 228 communicates a “Type-I” data message to local host site A, from which digital image 11 was uploaded. The Type-I data message communicated from managing entity 228 indicates that, at determination step 214, managing entity 228 determined that presently uploaded image 11 is similar to previously uploaded image 15, stored within database 30.

At step 228, the photo-sharing host site A receives the “Type-I” data message communicated from the managing entity 228 and responds by updating the local record associated with the subsequently presently uploaded digital image 11 to indicate to the uploading client X that he has attempted to use a digital image 11, which has been determined to be similar to a previously uploaded digital image 15 owned by another client Z. This process, involving the uploading photo-sharing host site A, utilized by client X, continues at step 254.

At step 230, a notification is issued by photo-sharing host site C to client Z, informing him that client X has attempted to subsequently upload and use a digital image 11 on local photo-sharing host site A, which has been determined to be similar to their digital image 15. This notification includes information regarding the identified redundancy, such as a link to view the profile page maintained by client X at local host photo-sharing site A.

At step 232, a determination is made by photo-sharing host site C as to the privacy settings requested by client Z for image 15, which were established at a point in time substantially coincident with the uploading of image 15 at local host photo-sharing site C.

At step 234, it is determined that client Z selected the “restricted” privacy settings for image 15 and the process, as it relates to local photo-sharing host site C, terminates. The process continues, pertaining to local photo-sharing host site A, continues at step 252.

At step 236, it is determined that client Z selected the “non-restricted” privacy settings for image 15 and the process, as it relates to local photo-sharing host site C, terminates. The process continues, pertaining to local photo-sharing host site A, continues at step 252.

At step 238, it is determined that client Z selected the “semi-restricted” privacy settings for image 15 and local photo-sharing host C sends a communication to client Z requesting that a decision be made regarding whether or not to allow client X to use presently uploaded image 11, which was determined to be similar to their previously uploaded image 15. Recall that at step 230, client Z was provided with information regarding client X and image 11 to make the usage decision concerning the allowance of denial of image 11, uploaded from client X.

At step 240, client Z decides whether or not to allow usage of image 11 by client X.

At step 242, at local photo-sharing host C, the local record associated with image file 15 is updated to reflect the usage decision by client Z.

At step 244, at local photo-sharing host C, the decision by client Z is communicated to the managing entity 228.

At step 246, the managing entity 228 receives the communication issued from client Z at the local photo-sharing host site C and updates rights profiles 110 and 150 associated with image files 11 and 15, respectively, to reflect the decision by client Z.

At step 248, managing entity 228 communicates the decision by client Z regarding the use of presently uploaded image 11 to local photo-sharing host A.

At step 250, local photo-sharing host A updates the local record associated with image 11.

At step 252, a determination is made as to whether client Z has decided to allow or deny the use of presently uploaded image 11 by client X. It is understood that a decision to allow usage of image 11 might have been made at the time client Z selected “non-restricted” or might have otherwise been made at step 240. Conversely, it is also understood that a decision to restrict or deny usage of image 11 might have been made when client Z selected the “restricted” option.

At step 254, having determined at step 252 that client Z either selected the “non-restricted” privacy setting or chose to allow the usage of image 11 (at step 240), client X is notified of the match by local photo-sharing host A.

At step 256, the process terminates.

At step 258, having determined at step 252 that client Z either selected the “restricted” privacy setting or chose to restrict the usage of image 11 (at step 240), the use of image 11 by client X is restricted at local photo-sharing host A.

At step 260, local photo-sharing host A notifies client X of the restriction of image 11 and a process for appeal.

At step 262, client X chooses whether or not to appeal the usage restriction imposed by the local photo-sharing host site A.

At step 264, in the case that client X chooses, at step 262, not to appeal the usage restriction, the process terminates.

At step 266, in the case that client X chooses, at step 262, to appeal the usage restriction, client X submits a request for arbitration and asserts their desired privacy settings associated with image 11.

At step 268, the photo-sharing host site A receives the appeal request from client X and communicates this request to managing entity 228.

At step 270, local photo-sharing host sites A and C collaborate with managing entity 228 to consider the appeal and make a determination whether to reverse the usage restriction imposed on presently uploaded image 11 from client X. In making this determination, the managing entity 228 may consider any number of relevant factors, including, for example, the original upload date of the original image provided by client Z, the number of “friends” within the networks of each client, the number of page-views per client, the geography of the client and other relevant factors as will assist in making a decision as to rightful ownership of the image.

At step 272, the determination is made by managing entity 228 whether the usage restriction on uploaded digital image 11 should be reversed.

At step 274, upon determining that the usage restriction on uploaded digital image 11 should not be reversed, the photo-sharing host sites A and C and managing entity 228 update their local records associated with the respective uploaded digital images 11 and 15 to reflect the appeal and rejection of appeal.

At step 276, the photo-sharing host sites A and C communicate the decision to clients X and Z, respectively.

At step 278, the process terminates

At step 280, upon determining that the usage restriction on uploaded digital image 11 should be reversed, the photo-sharing host sites A and C and managing entity 228 update their local records associated with respective uploaded digital images 11 and 15 to reflect the appeal and acceptance of the appeal.

At step 282, the respective local photo-sharing host sites A and C communicate the appeal decision to clients 10 and 16, respectively.

At step 284, local photo-sharing host site C restricts the use of image 15 by client Z.

At step 286, the process terminates.

FIG. 3 illustrates, by way of example, a data entry screen 300 (GUI) of the present invention, sometimes referred to herein as a preferences page 300. The preference page 300 may be presented to the uploading client X upon uploading his digital image 11 to the local photo-sharing host site A. The preference page 300 facilitates the selection of privacy settings. The selected privacy settings are stored in association with the uploaded digital image 11 as a local record on server 22 at the local photo-sharing host site A. The preference page 300 includes a privacy settings selection area 31, enabling uploading clients, such as client X, to establish privacy rights associated with an uploaded digital image, such as digital image 11, by selecting a desired level of security. In the presently described embodiment, an uploading client X uploading a digital image 11 has the option to select one of three levels of security protection, including, “restricted” 33, “semi-restricted” 35 and “not restricted” 37. Of course, other embodiments may include more or less levels of security protection in accordance with the specific needs of the user community.

The three levels of security protection that may be selected by an uploading client X at preference page 300 are now described in greater detail as follows.

### I—Restricted Protection

When a client selects the “restricted” protection privacy setting 33, the client implicitly stakes a claim as the rightful owner of an uploaded digital image. As the rightful owner, the client may restrict usage of the uploaded image by other users of the local photo sharing site storing the uploaded digital image. It should be understood that the term “usage,” in the context of restricting usage of an uploaded image, refers to denying other users from incorporating a given user's uploaded digital image into any other clients personalized photo album.

The election of the “restricted” protection setting 33 by a client has implications whenever another client subsequently uploads a digital image to one of the local photo-sharing host sites associated with the managing entity, and that subsequently uploaded digital image is determined to be similar to a digital image uploaded from another client at an earlier point in time. In this case, the use of the subsequently uploaded digital image is restricted at the uploading local photo-sharing host site. Further, the first uploading client, who is the rightful owner of the formerly uploaded digital image, is notified of a determination of similarity between the former and latter uploaded images. Such notification may be transmitted to the first uploading client by various means, including, for example, an e-mail notification, by a network webpage communication to the client, by a phone call, facsimile or any appropriate communication.

It is noted that the “restricted” protection setting 33 is generally recommended for an uploading client in the case where the client is the only subject included within the uploaded digital image and the image is meant to represent the uploading client to other users visiting the local photo-sharing host site.

### II—Semi-Restricted Protection

By selecting the “semi-restricted” protection privacy setting 35, a first uploading client claims his uploaded image as his own, but allows the usage of similar images which are subsequently uploaded by other clients for such time before the uploading client can make a usage decision. In one embodiment, this prescribed time begins from when a subsequently uploaded image, determined to be similar to the first uploaded image, is uploaded to a managing entity making a determination of similarity and ends at a point in time at which the first uploading client makes a determination regarding whether or not to allow the subsequently uploaded image, determined to be similar, to be ultimately used at the host web site.

When a client elects the “semi-restricted” protection privacy setting 35, in the event another client subsequently uploads a digital image to one of the local photo-sharing host sites associated with the managing entity and that subsequently uploaded image is determined to be similar to the first uploaded image supplied by the first uploading client, the use of the subsequently uploaded image is temporarily allowed by the local host site. The first uploading client is notified of a determination of similarity made at the local photo-sharing host system and is provided with the ability to choose whether or not to allow the use of the subsequently uploaded image by the second uploading client. Such notification may be transmitted to the first uploading client by various means, including, for example, an e-mail notification, by a network webpage communication to the client, by a phone call, facsimile or any appropriate communication.

It is noted that the “semi-restricted” protection option 35 is generally recommended in the case where the client is not the only subject within an uploaded digital image, and the image is not meant to solely represent the client to other users at the local photo-sharing host web site.

### III—Non-Restricted Protection

By selecting the “non-restricted” protection option 37 at the preference page 300, a client claims the uploaded digital image as his own, but allows the use of subsequently uploaded images from other users which are determined to be similar to the first uploaded digital image. Similar to that described above with respect to the restricted protection case, in the event another client subsequently uploads another image determined to be similar to the digital image uploaded from the first client, the first uploading client is notified of the subsequent upload. However, it should be appreciated that that this non-restricted protection option does not provide the first uploading client with the ability to allow or reject the use of the subsequently uploaded image supplied from another user. The first uploading client is powerless to allow or reject the subsequently uploading client from incorporating the first uploaded image into another personalized photo album at one of the local photo-sharing host web sites associated with the managing entity.

In general, the “non-restricted” protection option 37 is recommended to an uploading client in the case where the client is not the only subject (i.e., image) within his uploaded digital image, and the client is not sensitive to other users “using” his uploaded digital image, as defined herein.

FIG. 4 is an illustration of an exemplary rights profile 110 which is created as a result of clicking the “save” button 39 at preference page 300 (see FIG. 3) in association with any of the local photo-sharing host web sites A, B and C. The rights profile 110 is preferably stored in a standard record format at local server 22 and includes at least the uploaded digital image 11 and certain privacy right settings 44 established in accordance with the preference page settings. The rights profile might additionally include other data 46 associated with the image file, such as the level of protection requested by the client, upload date, the URL associated with the uploaded image, the image size and the ISP of the client at the point of upload. In some embodiments, the rights profile may also contain a record of any additional instances 48 of the uploaded digital image 11 for which the rights profile was created. These additional instances may have been uploaded by other clients of the network, and whether that picture is allowed or restricted.

### Similarity of Two Digital Images

It is instructive to describe the criteria that may be used to determine when two images constitute a so-called “match.” This aspect of the invention relies on an existing field of technology that specializes in pattern matching and image recognition that is well-known. Such technology has historically been utilized by government agencies to compare pictures of criminals, for example identifying criminals in crowds based upon photos which are entirely different photographs of the same object (generally an individual's face). Such technology has also been used by content owners to screen the internet and other such large databases to locate unlicensed copies of trademarked materials, including but not limited to graphic images. In the present application, this same technology may be used to search for images that contain similar objects or similar images. Lastly, such technology has been articulated as a means of screening large amounts of picture data to identify and control content that would not be appropriate for viewers, for example minors.

Presently, one particular technology company that leads the field in searching image databases to find similar images is LTU technologies of Washington, D.C. and Paris, France. LTU technologies licenses a proprietary technology to segment areas of pictures and index pictures according to their visual properties in a manner that allows for rapid search to find similar pictures, where the degree of similarity can range from duplicates (exactly alike), to cloned images (same image, but edited or transformed) to similar images (contains like elements). The applications articulated by LTU technologies are law enforcement, trademark infringement and image screening for the internet. LTU technology, which can be implemented as a solution for many applications, is not presented in any manner known to Applicants that indicates it has been conceptualized or employed to link consumer records associated with pictures that are similar. Such a system, when implemented as described herein in accordance with the present invention, facilitates the collaborative generation of content related to images uploaded by distinct individuals to distinct locations, where content related to all instances of an image can be associated and integrated. Such a system further allows for networking applications that allow users that own like photos that have either been separated by time or distance to share information without strict access to any one version of a file

### Other Embodiments

According to one embodiment of the present invention, rather than transmit the actual image file within a record format from the local photo-sharing host to be stored at the managing entity, representative meta-data might be extracted from the file at the local photo-sharing host level and transmitted to the managing entity to facilitate the cataloging and comparison of images.

According to yet another embodiment, the present invention might be implemented together with the invention taught within U.S. Patent Application entitled “System and method for linking data related to a set of similar images,” (Attorney Docket No. J107U034US00, filed Feb. 16, 2007, to Loeb, M. R. et al.), incorporated herein by reference in its entirety, which provides a process for creating centralized records for pictures uploaded to a local photo-sharing host site, matching images contained with those records and linking data associated with those matched images in a manner that encourages collaborative data-sharing. In this embodiment, upon determining that the first uploader and rights owner of an image has provided supplementary data related to their image, and further allows other users to use their image on their own photo-sharing host site, a notification is sent to the uploading user communicating providing them the ability to integrate this supplementary data into their own

There have thus been provided new and improved methods and systems for providing photographic rights management and identity protection.

While the invention has been shown and described with respect to particular embodiments, it is not thus limited. Numerous modifications, changes and enhancements will now be apparent to the reader.

1-27. (canceled)

28. A computer-implemented method for providing photographic rights management and identity protection at an uploading host site, the method comprising:
a) uploading images to a plurality of local servers, each local server being configured to enable users to upload and maintain images, said uploads further including at least user specified privacy setting meta-data associated with the uploaded images, each of said local servers being a host computer for a respective photo-sharing web site, each of said photo-sharing web sites used for social networking purposes,
b) forwarding a copy of the images uploaded from each of the local servers and the corresponding associated user specified privacy setting meta-data to a central server to be evaluated at the central server for identity protection and photographic rights management,
c) comparing, at said central server, a currently uploaded image from a current user, with all of the previously uploaded images uploaded from other users at earlier points in time relative to the upload of the currently uploaded image to determine whether said currently uploaded image is similar to at least one of said previously uploaded images, wherein said currently uploaded image-and said previously uploaded images are non-associated images uploaded from different users and are not watermark images,
d) identifying, based on said comparison performed at said central server, at least one previously uploaded image from among all of said previously uploaded images to be similar to said currently uploaded image, wherein similarity is based on pattern matching and image recognition techniques,
e) retrieving, at the central server, the user specified privacy meta-data to the identified similar image to determine a level of restriction specified by the privacy meta-data,
f) restricting said current user's usage rights associated with said current user's currently uploaded image by notifying the current user that the currently uploaded image will be removed from the local server, in the case where the user specified privacy meta-data associated with the identified similar image is set to restricted status,
g) semi-restricting said current user's usage rights associated with said current user's currently uploaded image by notifying the current user that the currently uploaded image will be allowed for a limited period of time until a final status determination is made, in the case where the user specified privacy meta-data associated with the identified similar image is set to restricted status,
h) not restricting said current user's usage rights associated with said current user's currently uploaded image by notifying the current user that the currently uploaded image of the current user will be allowed to be maintained on the local server, in the case where the user specified privacy meta-data associated with the identified similar image is set to non-restricted status.

29. The computer-implemented method of claim 28, wherein said usage restriction status determines usage rights applied to subsequently uploaded images that are determined to be similar such as said currently uploaded image.

30. The computer-implemented method of claim 28, wherein said usage restriction status is received from a user uploading said previously uploaded similar image.

31. The computer-implemented method of claim 28, further comprising: informing a user associated with the previously uploaded similar image that an attempt has been made to upload and use the currently uploaded image, determined to be similar at said step (b).

32. The computer-implemented method according to claim 28, further comprising: permanently allowing the usage of the currently uploaded image based on a de-activated usage restriction status associated with said previously uploaded similar image.

33. The computer-implemented method of claim 28, further comprising: informing a user associated with the previously uploaded similar image that usage of the currently uploaded image was allowed, based on a de-activated usage restriction status associated with said previously uploaded similar image.

34. The computer-implemented method according to claim 28, further comprising: provisionally allowing the usage of the currently uploaded image based on a provisionally de-activated said usage restriction status associated with said previously uploaded similar image.

35. The computer-implemented method according to claim 34, further comprising: converting said provisionally de-activation to one of a permanent activation or permanent de-activation.

36. The computer-implemented method according to claim 35, wherein said conversion of the provisional de-activation is based on a final determination received from a user who has previously uploaded the previously uploaded similar image.

37. The computer-implemented method of claim 28, wherein said comparing step further comprises: comparing said currently uploaded image with said plurality of previously uploaded images to identify like elements in each of said compared images.

38. The computer-implemented method of claim 28, further comprising: informing a user associated with the currently uploaded image that a conflict exists between the currently uploaded image and said previously uploaded similar image, resulting in a usage restriction of the currently uploaded image and of a process for appealing the usage restriction.

39. The computer-implemented method of claim 28, further comprising: said user initiating said process for appealing the usage restriction.

40. The computer-implemented method of claim 39, wherein said appeal process comprises: submitting a request for arbitration and asserting one or more desired privacy settings.

41. The computer-implemented method of claim 40, further comprising: making a determination regarding whether or not to reverse the usage restriction based on said appeal.

42. A system for providing photographic rights management and identity protection, the system comprising:
a processor;
a memory connected to the processor and storing instructions for operating the processor to perform the steps of:
uploading images to a plurality of local servers, each local server being configured to enable users to upload and maintain images, said uploads further including at least user specified privacy setting meta-data associated with the uploaded images, each of said local servers being a host computer for a respective photo-sharing website, each of said photo-sharing websites used for social networking purposes,
forwarding a copy of the images uploaded from each of the local servers and the corresponding associated user specified privacy setting meta-data to a central server to be evaluated at the central server for identity protection and photographic rights management,
comparing, at said central server, a currently uploaded image, from a current user, with all of the previously uploaded images-uploaded from other users at earlier points in time relative to the upload of the currently uploaded image to determine whether said currently uploaded image is similar to at least one of said previously uploaded images, wherein said currently uploaded image-and said previously uploaded images are non-associated images uploaded from different users and are not watermark images,
identifying, based on said comparison performed at said central server, at least one previously uploaded image from among all of said previously uploaded images to be similar to said currently uploaded image, wherein similarity is based on pattern matching and image recognition techniques,
retrieving, at the central server, the user specified privacy meta-data corresponding to the identified similar image to determine a level of restriction specified by the privacy meta-data,
restricting said current user's usage rights associated with said current user's currently uploaded image by notifying the current user that the currently uploaded image will be removed from the local server, in the case where the user specified privacy meta-data associated with the identified similar image is set to restricted status,
semi-restricting said current user's usage rights associated with said current user's currently uploaded image by notifying the current user that the currently uploaded image will be allowed for a limited period of time until a final status determination is made, in the case where the user specified privacy meta-data associated with the identified similar image is set to restricted status,
not restricting said current user's usage rights associated with said current user's currently uploaded image by notifying the current user that the currently uploaded image of the current user will be allowed to be maintained on the local server, in the case where the user specified privacy meta-data associated with the identified similar image is set to non-restricted status.

43. The system of claim 42, further comprising: informing a user associated with the previously uploaded similar image that an attempt has been made to upload and use the currently uploaded image at a local photo-sharing web site.

44. The system of claim 42, further comprising:
further comprising: permanently allowing the usage of the currently uploaded image based on a de-activated said usage restriction status associated with said previously uploaded similar image.

45. The system of claim 42, further comprising:
informing a user associated with the previously uploaded similar image that usage of the currently uploaded image was allowed, based on a de-activated usage restriction status associated with said previously uploaded similar image.

46. The system of claim 42, further comprising:
provisionally allowing the usage of the currently uploaded image based on a provisionally de-activated said usage restriction status associated with said previously uploaded similar image.

47. The system of claim 42, further comprising:
converting said provisionally de-activation to one of a permanent activation or permanent de-activation.
